(19) United States
(12) Patent Application Publication
(10) Pub. No.: US 2026/0061660 A1
(43) Pub. Date: Mar. 5, 2026

(54) CUTTING DRUM AND MULTI-PIECE CUTTING BLADE ASSEMBLY

(71) Applicant: Dyna Sales and Service LLC, Oakland Twp, MI (US)

(72) Inventors: Michael Miller, Millington, MI (US); Nathan Miller, Millington, MI (US); Frank Force, Roscommon, MI (US); Thomas Gross, Weidman, MI (US)

(73) Assignee: Dyna Sales and Service LLC, Oakland Twp, MI (US)

(21) Appl. No.: 19/313,512

(22) Filed: Aug. 28, 2025

Related U.S. Application Data
(60) Provisional application No. 63/688,225, filed on Aug. 28, 2024.
(60) Provisional application No. 63/717,256, filed on Nov. 6, 2024.

(51) Int. Cl. B27L 11/00

(52) U.S. Cl. CPC B27L 11/005

(57) ABSTRACT

A machine or device for reducing material including a cutting drum and/or removable, multipiece cutting blade assembly. A machine for reducing material that includes a skinless cutting drum. In one aspect there is disclosed a woodchipper for reducing material that includes a skinless cutting drum and a discharge assembly.

### CROSS-REFERENCE TO RELATED APPLICATIONS

The present invention relates to and is entitled to the benefit of the earlier filing dates and priority of: U.S. Provisional Ser. No. 63/688,225 entitled SKINLESS CUTTING DRUM filed Aug. 28, 2024, naming Thomas R. Gross as an inventor, and to U.S. Provisional Ser. No. 63/717,256 , entitled CUTTING DRUM WITH MULTI-PIECE CUTTING BLADE ASSEMBLY, filed Nov. 6, 2024, naming Michael Miller, Nathan Miller, and Frank Force as inventors, the disclosures of which are hereby incorporated herein by reference in their entirety.

### BACKGROUND

### Background of the Invention

### I. Field of the Invention

The present invention relates to machines and devices for reducing materials, including materials made of wood or other fibrous materials, and more particularly to drum chippers.

### II. Description of the Background

Drum chippers and shredders for reducing wood are generally known and have been described by Thomas Gross and his associates in a number of publications including: U.S. Pat. No. 9,308,533, entitled Shredder With Side Discharge; U.S. Pat. No. 8,118,245, entitled Self-contained Shredder Assembly for Reducing and Sizing Material; U.S. Pat. No. 7,909,275 entitled Self-contained Shredder Assembly for Reducing and Sizing Material; U.S. Pat. No. 7,552,884 entitled Drum Shredder with Flywheel or Discharge Assembly; U.S. Pat. No. 7,513,449 entitled Wood Collection and Reducing Machine; and U.S. Pat. No. 6,824,089 entitled Wood Collection and Reducing Machine, the disclosures of which are hereby incorporated herein by reference in their entirety.

However, what is needed is a device for reducing material that can be manufactured at one or more of: a lower cost, with less weight, improved reliability, improved longevity, improved serviceability, or improved processing material efficiency. What is also needed is a component assembly that can be used as a replacement assembly or kit for a woodchipper in the aftermarket that is effective but with less weight or cost.

### SUMMARY OF THE INVENTION

Described herein are devices for reducing material including: a shredder, a cutting drum, and a multipiece cutting blade assembly. The device for reducing material may include one or more structures for chipping, carrying, or blowing material. The device may be a woodchipper or a component for a woodchipper. The device may be a cutting drum for a woodchipper. A cutting drum for a woodchipper can provide a means for chipping or reducing material, for example wood, pulp, fiber, or other material.

In one aspect of the disclosure there is provided a woodchipper with one or more components for chipping, sizing, carrying, discharging, or blowing material. A component for a woodchipper may be provided as an optional or replacement part for a woodchipper or other suitable device.

In another aspect there is provided a cutting drum. The cutting drum may be skinless or have a drum skin. The cutting drum may be adapted for use with a woodchipper. The cutting drum may support one or more multipiece cutting blade assemblies.

In another aspect there is provided a multipiece cutting blade assembly. The multipiece cutting blade assembly may provide one or more: ease of maintenance, ease of replacement, ease of assembly, reduced cost of replacement, choice wear characteristics, enhanced material processing, reduced clogging, process material carrying, enhanced material reduction, sizing, or other features.

The multipiece cutting blade assembly may include a cutting knife and counter knife. The cutting knife may be removably attached to the counter knife. The cutting knife and counter knife may be removably attached to a fixed blade support or knife holder. The blade support or knife holder may be fixed to a cutting drum. The counter knife may be positioned to shield a knife holder from direct processed material impact. The counter knife may have a processed material impact surface. The processed material impact surface may be angled in a direction away from the blade edge of a cutting knife. The cutting knife may have a pocket undercut. A cutting knife pocket undercut may provide an expansion volume for processed material. An expansion volume may aid in material processing with reduced clogging.

For a more complete understanding of the claimed invention, reference is now made to the accompanying drawings, Description of Embodiments and Claims. The systems and devices given in the figures are for example and may alternatively or additionally have other components or features as disclosed in the specification, drawings, and priority filings.

### BRIEF DESCRIPTION OF THE DRAWINGS

FIG. 1 is a perspective view of an embodiment of a device for reducing material.

FIG. 2 is an environmental view of a device for reducing material having a discharge assembly and a cutting drum.

FIG. 3a is a side, cross-sectional view of an embodiment of a machine for reducing material including a multipiece cutting blade assembly.

FIG. 3b is an exploded side view of an embodiment of a machine for reducing material as shown in FIG. 3a.

FIG. 3c is a top view of an embodiment of a machine for reducing material including a cutting knife.

FIG. 3d is a perspective view of an embodiment of a machine for reducing material including a counter knife.

FIG. 4 is an environmental view of an embodiment of a machine for reducing material including a cutting knife.

FIG. 5 is an environmental view of an embodiment of a machine for reducing material including a cutting knife.

FIG. 6 is an environmental view of an embodiment of a machine for reducing material including a cutting knife.

FIG. 7 is an environmental view of an embodiment of a machine for reducing material including a cutting knife.

FIG. 8 is an environmental view of an embodiment of a machine for reducing material including a cutting knife.

FIG. 9 is an environmental view of an embodiment of a machine for reducing material including a cutting knife.

FIG. 10 is an environmental view of an embodiment of a machine for reducing material including a cutting knife.

FIG. 11 is an environmental view of an embodiment of a machine for reducing material including a cutting knife.

FIG. 12 is an environmental view of an embodiment of a machine for reducing material including a cutting knife.

FIG. 13 is an environmental view of an embodiment of a machine for reducing material including a cutting knife.

### DESCRIPTION OF EXAMPLE EMBODIMENTS

In one embodiment there is provided a rotatable cutting structure with a plurality of cutting implements.

In another embodiment there is disclosed a machine for reducing material which includes a rotatable structure with substantial open space. Open space may provide a mechanism for chip or material discharge. The open space may allow processed material to transvers the inside of the structure at a plane less than the cross-sectional diameter of the structure. The substantial open space may comprise over 25%, 50%, or more of the rotatable structure. Open space may provide weight reduction and/or ease of manufacture. The rotatable structure may include parallel disc members. The rotatable structure may be a skeletal structure. The rotatable structure may be a cylindrical structure. A rotatable, skeletal structure with substantial open space may allow processed material to transverse the inside of the structure to aid in material discharge.

The skeletal structure may include a network of connected frame members. The frame members may include one or more disc members, cross members, or both. The frame members may provide a controlled material feed structure at the cutting zone. The feed control structure may be provided by frame members sized, shaped, and positioned to space material feed at the skeletal structure cutting zone. The feed control structure may be provided by the disc member at least in part or in total. The frame members may space material feed at the structure circumference, opposite the position of a cutting implement, or any other suitable position during operation.

The frame members may be welded together. A skeletal structure can provide superior weldments where angles of the inner structure can be advantageously accessed for welding. Weldments may connect disc members to crossmembers to form the rotatable structure. The disc members may be uniformly spaced along an axis. The disc members may provide support for one or more cutting implements positioned on the cylindrical structure. The support may be a knife holder. A knife holder may provide a removable mount for one or more cutting implements.

The cutting implements may be multi-piece. The cutting implement may be a knife. One or more knives may be mounted to the outer surface of the structure. The knives may be disposed about the drum in uniform pattern and act to cut and/or mulch woody and other fibrous material as it is fed into the cutting zone.

In operation the cutting structure is rotated and material for reduction is feed to the cutting zone of the rotating cutting structure. The material for reduction may be fibrous material such wood, branches, logs, or other material.

The cutting implement holders may include such mass as to add flywheel weight. The cutting implement holders may be sized and weighted to provide balance to the rotatable structure. A holder may be positioned on and adjoining the parallel disc members of a drum at, near or beyond the outer surface of the disc members. The holders may be positioned as far from the axis of the drum as possible. The holders may be positioned between and in the outer area of the parallel disc members to add structural strength when welded. Holders may be positioned to provide easy access to bolts and nuts. The holders may be positioned fully exposed for knife maintenance and replacement.

In another embodiment there is provided a rotatable cutting structure with a fan blade system. The fan blade system may be integrated with the rotatable cutting structure.

The integrated fan blade system may be positioned at least in part within the framework of the rotatable cutting structure.

In another embodiment there is provided a machine for reducing material which includes a rotatable cutting structure with pockets. Pockets may be used to carry processed material away from the cutting zone of the cutting structure.

In another embodiment there is provided a skinless cutting drum. The skinless cutting drum may include one or more pockets and an integrated fan blade system. The fan blade system may be disposed substantially within the drum structure. A skinless drum with pockets and an integrated fan blade system positioned substantially within the drum structure can be used to chip, carry, and discharge chips or other processed material.

FIG. 2 shows an environmental view of a device for reducing material 200 having a cutting drum 202. The device for reducing material 200 may include one or more components as described, depicted or claimed in the specification. As exemplified in this embodiment, the cutting drum may be part of a woodchipper. The woodchipper, in addition to a cutting drum 202, may also have one or more of a power source for rotating the drum, a housing 204, an infeed 206, a transition 208, or a discharge 210.

The cutting drum 202 may be provided as an aftermarket replacement or option for a woodchipper. The cutting drum 202 when provided as an aftermarket replacement may include an assembly kit.

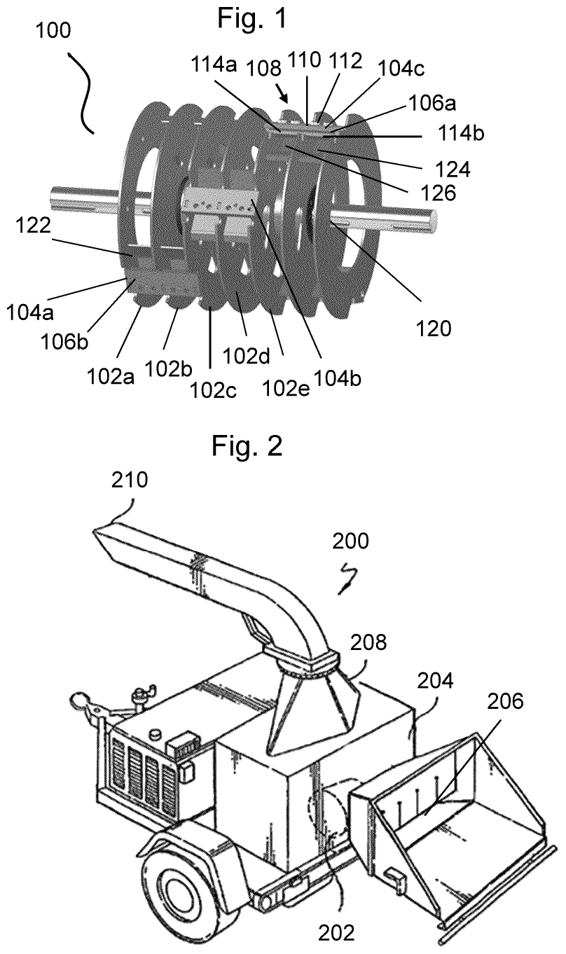

Referring now to FIG. 1, depicting therein at 100 is a cutting drum for a woodchipper or other suitable material reduction machine. The cutting drum may have a plurality of discs 102a, 102b, 102c, 102d, 102e. The plurality of discs 102a, 102b, 102c, 102d, 102e are rotatable about an axis. The discs may be concentric about the axis. One or more of the discs may be substantially parallel to each other. Two or more discs may be of essentially equal diameter. The discs may establish the outer perimeter of the cutting drum. The plurality of discs 102a, 102b, 102c, 102d, 102e may be supported by a hub 120. As shown the cutting drum is skinless. The plurality of discs may be arranged in an essentially cylindrical, skinless drum pattern. Plating may be disposed on the outside of the disks to make a skinned, cutting drum when desired.

The cutting drum 100 may include one or more knife holders 104a, 104b, 104c. The knife holder(s) may each have a cutting blade support 106a, 106b. The knife holders may be separate and distinct from the multipiece cutting blade assembly. The knife holder(s) may be attached across two or more of the discs. The knife holder(s) may be disposed in a disc set back location, as measured from the outer disc radius. The knife holder(s) may be permanently affixed to the cutting drum or form part of a weldment. The knife holders 104a, 104b, 104c may each include a metal plate. The metal plate may be welded to one, two, three, or more discs. As shown, the knife holder(s) 104a, 104b, 104c are attached across three discs each. The knife holders as shown are also attached and overlapping on at least one disc. Overlapping on at least one disc provides liner coverage across the cutting region where multiple knife holders are used across the length of a cutting drum.

The cutting drum 100 may have at least one multipiece cutting blade assembly 108. The cutting blade assembly 108 may include a cutting knife 110 and an anchor 112. The cutting knife 110 may be removably attached to the cutting blade support 106a with the anchor 112. The anchor may include one or more nut plates, 114a, 114b. The anchor may include one or more fasteners. The fasteners may connect a nut plat to a knife holder. Different fasteners may connect a nut plate to a cutting knife.

The cutting knife, counter knife, and at least 2 of the plurality of discs may form at least part of a deflector 124, 126 for processed material. The cutting drum may have a processed material expansion volume adjacent and downstream from the cutting knife. The processed material expansion volume may be formed at least in part by one of the plurality of discs. The expansion volume may be irregular shaped.

The cutting drum may include a processed material deflector. The processed material deflector may be disposed downstream from the cutting knife and any counter knife. The processed material deflector may be disposed between at least two of the plurality of discs. The processed material deflector may be a plate or ramp disposed between at least two of the plurality of discs. The processed material deflector may be open at two locations. The openings may be arranged in any suitable manner for processed material to enter one opening and exit at the other opening.

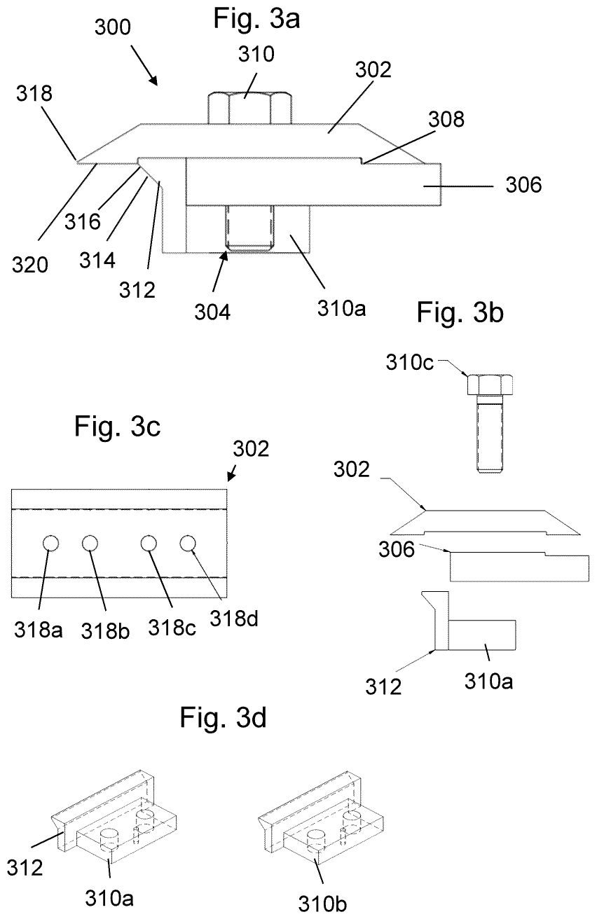

FIG. 3a is a side view of an embodiment of the machine for reducing material including a multipiece cutting blade assembly 300. FIG. 3b is an exploded side view of the multipiece cutting blade assembly 300 shown in FIG. 3a. The cutting blade assembly 300 may include a cutting knife 302 and an anchor 304. The cutting knife 302 has a blade edge 318. FIG. 3c is a top view of the cutting knife 302 shown in FIGS. 3a and 3b. The cutting blade may be reversable and with a second cutting edge. The second cutting edge may be held in reserve to be selectively rotated into service should the first edge become dulled or damaged.

The cutting knife 302 may be removably attached to a knife holder 306 with the anchor 304. The cutting knife may have one or more thru holes 318a, 318b, 318c, 318d. The knife holder 306 may have a cutting blade support 308. As shown the cutting knife 302 is keyed to the cutting blade support 308. The anchor 304 may include one or more nut plates, 310a, 310b. The anchor 304 may include one or more fasteners 310c. The fastener(s) 310c may be threaded, as shown.

The cutting blade assembly may include a counter knife 312. FIG. 3d depicts a perspective view showing an exemplary counter knife 312 for a cutting blade assembly. The counter knife 312 may be attached to an anchor component. As shown, the anchor component is a nut plate 310a. The cutting blade support may be threadless. The cutting blade support may have one or more threadless thru holes. The cutting knife may be attached to the knife holder by means of the thru holes and the anchor. For example, the anchor may include a nut plate, a nut plate fastener, and a cutting knife fastener. The nut plate fastener may anchor the knife holder to the nut plate. The cutting knife fastener may in turn anchor the cutting knife to the nut plate. As such the cutting knife is removable supported by the cutting blade support with smooth bore thru holes.

The counter knife 312 may have a wear surface 314. The counter knife 312 may be positioned to shield the knife holder 306 from direct processed material impact. The wear surface 314 may have a processed material impact surface 316. The processed material impact surface 316 may be angled in a direction away from the blade edge 318, i.e. the edge that is in service. Preferably the processed material impact surface 314 may be angled in a direction away from the blade edge at an angle from 5 to 70 degrees relative to the bottom of the knife. The processed material impact surface may be angled in a direction away from the blade edge at an angle from 15 to 60 degrees relative to the bottom of the knife. An angled surface may advantageously aid in further processed material reduction or flow.

The cutting knife may have an overhang 320 extending from the blade edge 318 to the counter knife 312. The overhang has a lead edge region and a transition region downstream and adjacent to the edge region. The transition region may provide an volume expansion with a cross-sectional area that is larger than a cross-sectional area at the lead edge region.

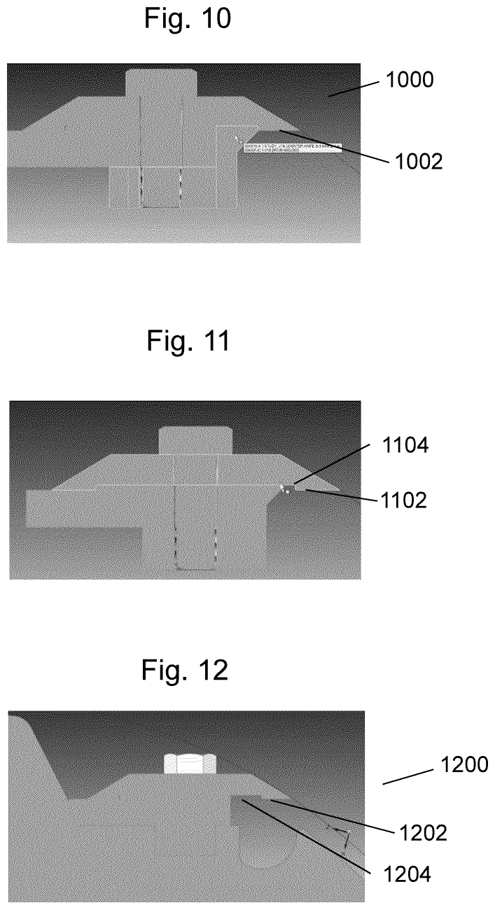

Alternative embodiments of a cutting knife overhang are shown in FIGS. 10, 11, and 12. As shown in FIG. 10, the cutting knife 1000 has a counter knife overhang 1002 with a transition that is uniform or flush from the blade edge to the counter knife. As shown in FIG. 11, the cutting knife has a counter knife overhang 1102. The counter knife overhang 1102 has a step transition 1104 or a sub flush surface region. A counter knife overhang 1102 with a step transition 1104 can provide a cutting knife pocket and a counter knife pocket overhang. As shown in FIG. 12, the cutting knife has a base and an overhang 1202 but lacks a counter knife. The overhang 1202 includes a step transition 1204. The cutting knife overhang includes a lead region surface gapped from the cutting knife base to provide a cutting knife pocket and a cutting knife pocket overhang.

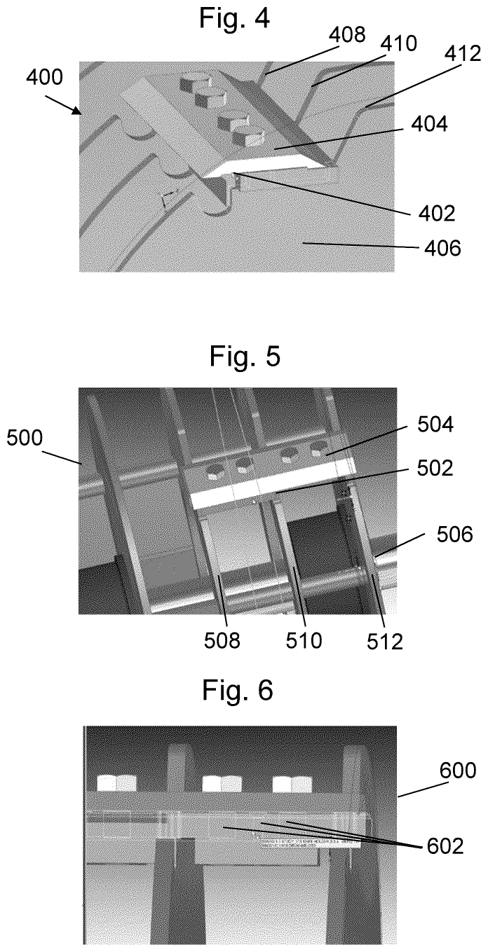

FIG. 4 depicts an environmental view of an embodiment of a machine 400 for reducing material including a multipiece cutting blade assembly 402 with a cutting knife 404 supported by a cutting drum 406 with a plurality of disc members 408, 410, 412.

FIG. 5 depicts an environmental view of an embodiment of a machine 500 for reducing material including a multipiece cutting blade assembly 502 with a cutting knife 504 supported by a cutting drum 506 with a plurality of disc members 508, 510, 512.

FIG. 6 depicts an environmental view of an embodiment of a machine 600 for reducing material including a multipiece cutting blade assembly with a cutting knife supported by a cutting drum with a plurality of disc members. The assembly further depicts thru holes for one or more fasteners 602.

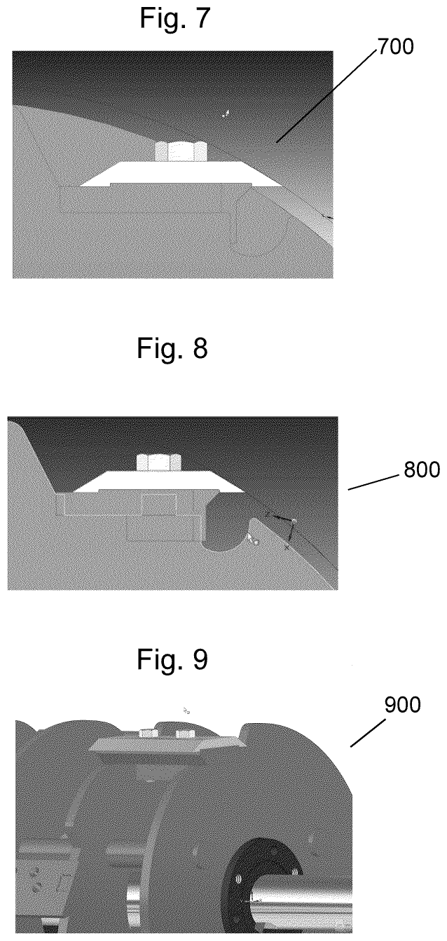

FIG. 7 depicts an environmental view of an embodiment of a machine for reducing material including a multipiece cutting blade assembly with a cutting knife supported by a cutting drum with a plurality of disc members.

FIG. 8 depicts an environmental view of an embodiment of a machine for reducing material including a multipiece cutting blade assembly with a cutting knife supported by a cutting drum with a plurality of disc members.

FIG. 9 depicts an environmental view of an embodiment of a machine 900 for reducing material including a multipiece cutting blade assembly with a cutting knife supported by a cutting drum with a plurality of disc members.

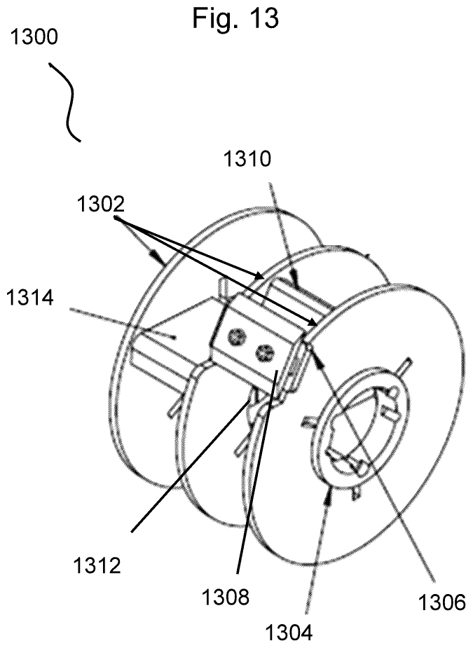

Referring now to FIG. 13, shown therein at 1300 is another embodiment of a rotatable cutting structure with a plurality of cutting implements (one of which is shown). The cutting structure 1300 is depicted as a skinless cutting drum which includes a plurality of discs 1302, a hub, a knife holder 1306, a pocket 1310, a knife 1308, frame members, open space 1312, a fan blade 1314 and a shaft 1304. The disc members are essentially parallel and coaxial. The one or more knife holders are each attached across at least two disc members. The knives are wider than deep or heigh, as viewed from the front view presented. Frame members provided as cross members are attached across two or more discs. Knives are shown attached to the knife holders. The knife holders, knives, cross members, pockets, and fan blades maybe essentially balanced around the skinless cutting drum and may be positioned to offset the weight of each other.

The fan blades may be integrated with a skinless cutting drum. In this embodiment the fan blades can be positioned opposite each pocket and between parallel knife holder discs.

The fan blades may be positioned starting at the surface of the drum and stretching toward the axis of the drum. The fan blades may extend at least 50% of the distance from the drum surface to the axis of rotation centerline. The fan blades may generate air flow during the chipping process. The fan blades may draw and force air into the chip stream from outside of the drum. Generating air from integrated fan blades into the chip stream from within and behind the chip stream may create less turbulence within its chips stream, enhance airflow and provide efficiency to the discharge process. The fan blades may have varying thickness. The varying thickness may add strength and mass to the drum and may create flywheel momentum as the drum rotates about the centerline axis.

As may be appreciated by the specification and drawings, what has been described is a skinless cutting drum that may be rotated with suitable cutting implements attached which in turn chip, shred, and reduce material feed into the cutting zone.

What is claimed is:

1. An apparatus for cutting or mulching wood comprising: a skinless cutting drum and a cutting blade assembly supported on the skinless cutting drum.

2. A cutting drum for a woodchipper comprising:
a plurality of discs, the plurality of discs rotatable about an axis;
a knife holder attached across two or more of the discs, the knife holder having a cutting blade support; and
a multipiece cutting blade assembly, the cutting blade assembly including a cutting knife and an anchor, the cutting knife removably attached to the cutting blade support with the anchor.

3. The cutting drum of claim 2 wherein the multipiece cutting blade assembly further includes at least one counter knife, the at least one counter knife having a wear surface, the counter knife being positioned to shield the knife holder from direct processed material impact.

4. The cutting drum of claim 3 wherein the cutting knife has a blade edge and the wear surface has a processed material impact surface, the processed material impact surface being angled in a direction away from the blade edge.

5. The cutting drum of claim 4, wherein the processed material impact surface is angled in a direction away from the blade edge at an angle from 5 to 70 degrees relative to the bottom of the knife.

6. The cutting drum of claim 5, wherein the processed material impact surface is angled in a direction away from the blade edge at an angle from 15 to 60 degrees relative to the bottom of the knife.

7. The cutting drum of claim 3, wherein the cutting knife, counter knife, and at least 2 of the plurality of discs form at least part of a deflector for processed material.

8. The cutting drum of claim 3, wherein the cutting knife has a counter knife overhang extending from the blade edge to the counter knife.

9. The cutting drum of claim 8, wherein the counter knife overhang has a step transition.

10. The cutting drum of claim 2, wherein the cutting blade support is threadless.

11. The cutting drum of claim 2, wherein the cutting knife is keyed to the cutting blade support.

12. The cutting drum of claim 2, wherein the cutting blade support has one or more threadless thru holes, the cutting knife being attached to the knife holder by means of the thru holes and the anchor.

13. The cutting drum of claim 12, wherein the anchor includes a nut plate, a nut plate fastener, and a cutting knife fastener, the nut plate fastener anchoring the knife holder to the nut plate and the cutting knife fastener anchoring the cutting knife to the nut plate.

14. The cutting drum of claim 2, wherein the plurality of discs are arranged in an essentially cylindrical, skinless drum pattern and the knife holder is welded across two or more discs to become part of a drum weldment.

15. The cutting drum of claim 8, wherein the cutting knife pocket overhang has a lead region with a lead region surface and a counter knife transition region with a transition surface, the transition surface being sub flush relative to the lead region surface.

16. The cutting drum of claim 8, wherein the cutting knife pocket overhang has a lead region with a lead region surface and a counter knife transition region with a transition surface, lead region surface is gapped from the counter knife.

17. The cutting drum of claim 2, wherein the cutting knife has a base and a deflector overhang, the deflector overhang having a lead region surface gapped from the cutting knife base.

18. The cutting drum of claim 2, wherein the cutting knife has an overhang, the overhang has a lead edge region and a transition region downstream and adjacent to the edge region, the transition region having an expansion with a cross-sectional area that is larger than a cross-sectional area at the lead edge region.

19. The cutting drum of claim 2, wherein at least one of the plurality of discs adjacent and downstream from the cutting knife has a processed material expansion volume.

20. The cutting drum of claim 18, wherein the expansion volume has an irregular shape.
